(19) United States
(12) Patent Application Publication
(10) Pub. No.: US 2008/0244667 A1
(43) Pub. Date: Oct. 2, 2008

(54) BANDWIDTH SENSITIVE SWITCHED DIGITAL VIDEO CONTENT DELIVERY

(76) Inventor: Jason C. Osborne, Lilburn, GA (US)

Correspondence Address: Wm. Brook Lafferty;Scientific-Atlanta, Inc., Intellectual Property Dept. MS 4.3.518, 5030 Sugarloaf Parkway, Lawrenceville, GA, 30044, US

(21) Appl. No.: 11/691,565

(22) Filed: Mar. 27, 2007

(51) Int. Cl. H04N 7/173

(52) U.S. Cl. 725/94

(57) ABSTRACT

Systems and methods are disclosed for enabling a switched digital video (SDV) server to prioritize SDV programs. More specifically, SDV programs carried on an RF carrier frequency are given priorities in the event of unavailable bandwidth. In this manner, the SDV server selects which SDV programs to broadcast, to unbind, or not to fulfill.

### FIELD OF THE INVENTION

This invention relates in general to broadband communications systems, and more particularly, to the use of delivering content in a bandwidth sensitive switched digital video system.

### BACKGROUND OF THE INVENTION

Broadband communications systems, such as satellite, cable television, and direct subscriber line (DSL) systems, are now capable of providing many services in addition to broadcast video. Additional services include video-on-demand (VOD), personal video recording (PVR), high definition television, online gaming, telelearning, video conferencing, voice services, and high speed data services. With an increase in the number of services offered, the demand for bandwidth has drastically increased.

In order to economize the available bandwidth in a system, a switched digital video (SDV) system includes devices and methods that broadcast selected services only upon an SDV client request. In this manner, services that are rarely viewed or only viewed by a few subscribers are not continuously broadcasted to subscribers until requested, thereby allowing available bandwidth for more frequently watched services. Even in an SDV system, however, there are limitations on the available bandwidth in the system. Thus, there exists a need for a more efficient system and method of delivering SDV services in a bandwidth sensitive SDV system.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 is an abridged block diagram of a communications system that is suitable for use in implementing the present invention.

FIG. 2 is an abridged block diagram of data provider devices that are suitable for use in the communications system of FIG. 1 as well as implementing an SDV system.

FIG. 3 is an abridged block diagram of program provider devices that are suitable for use in the communications system of FIG. 1 as well as implementing an SDV system.

FIG. 4 is an abridged block diagram of a set-top box (STB) that is suitable for use in implementing the present invention.

FIG. 5 is a block diagram of a television displaying a first SDV program on a main screen and a second SDV program on a PIP screen.

FIG. 6 is a block diagram of the television displaying a first SDV program on the main screen and the STB recording a second SDV program to memory.

FIG. 7 is a block diagram of the television displaying a main pay-per-view (PPV) SDV program on the main screen.

FIG. 8 is a block diagram of the STB 250 requesting a high definition (HD) SDV program that will be displayed on the main screen 505.

FIG. 9 is an illustration of the current programs that are grouped in TSID 34 and are broadcasted from SDV QAM out of output port RF4.

FIG. 10 illustrates an SDV server program log, which tracks current SDV programs.

FIG. 11 illustrates a new program select request from a STB requesting a program.

FIG. 12 illustrates the updated programs that are grouped in TSID 34 and are broadcasted from SDV QAM 320d out of output port RF4.

FIG. 13 illustrates an updated SDV server program log.

FIG. 14 illustrates a new program select request from a STB requesting an SDV program.

FIG. 15 illustrates an updated SDV server program log indicating the current STBs and their activity.

### DETAILED DESCRIPTION

Preferred embodiments of the invention can be understood in the context of a broadband communications system. Note, however, that the invention may be embodied in many different forms and should not be construed as limited to the embodiments set forth herein. All examples given herein, therefore, are intended to be non-limiting and are provided in order to help clarify the description of the invention.

The present invention is directed towards enabling a switched digital video (SDV) server to prioritize SDV services in order to maximize the available bandwidth. More generally, an SDV system is a system and method of maximizing the number of services, which carry programs, using a minimum amount of bandwidth. The SDV system and method allows popular services to continuously be broadcasted throughout the system, while other services are broadcasted only by request and then only if there is available bandwidth. By way of example, a specified group of popular services, such as ABC, CBS, FOX, HBO, etc., is broadcasted to every home and business in a system regardless of whether or not users are watching the service. Another specified group of services may be considered SDV services. These selected SDV services, for example, may be services that are rarely viewed or may be local services that do not always have programming available. In this manner, when an SDV client selects to receive an SDV service, an SDV server determines the available bandwidth and, if available, authorizes the broadcasting of the requested service. In accordance with the present invention, the SDV services themselves may be prioritized. In other words, among the selected SDV services, some may take priority over others. Accordingly, when bandwidth is limited, some lower priority SDV services may not be transmitted or may alternatively be transmitted in a degraded manner as will be discussed further below.

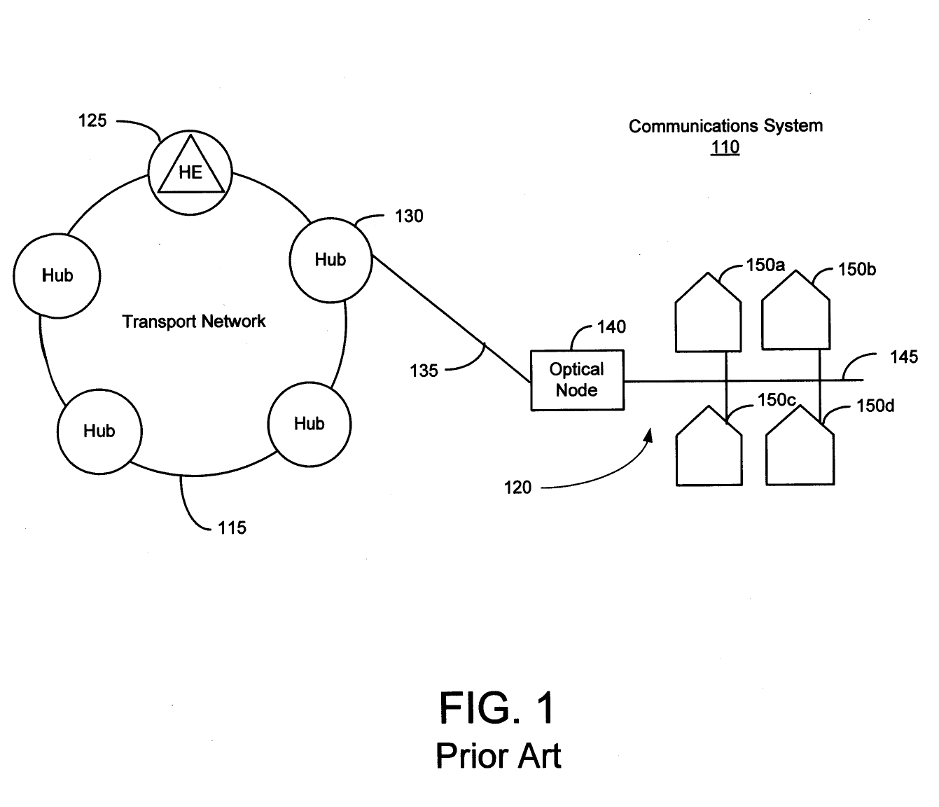

FIG. 1 is an abridged block diagram of a communications system 110 that is suitable for use in implementing the present invention. Typically, a communications system 110 includes a transport network 115 and a transmission network 120. The transport network 115, which is fiber optic cable, connects a headend 125 and hubs 130 for generating, preparing, and routing programs and other optical packets over longer distances; whereas a transmission network 120, which is coaxial cable, generally routes electrical packets over shorter distances. Programs and other information packets received, generated, and/or processed by headend equipment is either broadcasted to all subscribers in the system 110 or alternatively, the programs can be selectively delivered to one or more subscribers. Fiber optic cable 135 connects the transport network 115 to an optical node(s) 140 in order to convert the packets from optical packets into electrical packets. Thereafter, coaxial cable 145 routes the packets to one or more subscriber premises 150a-d.

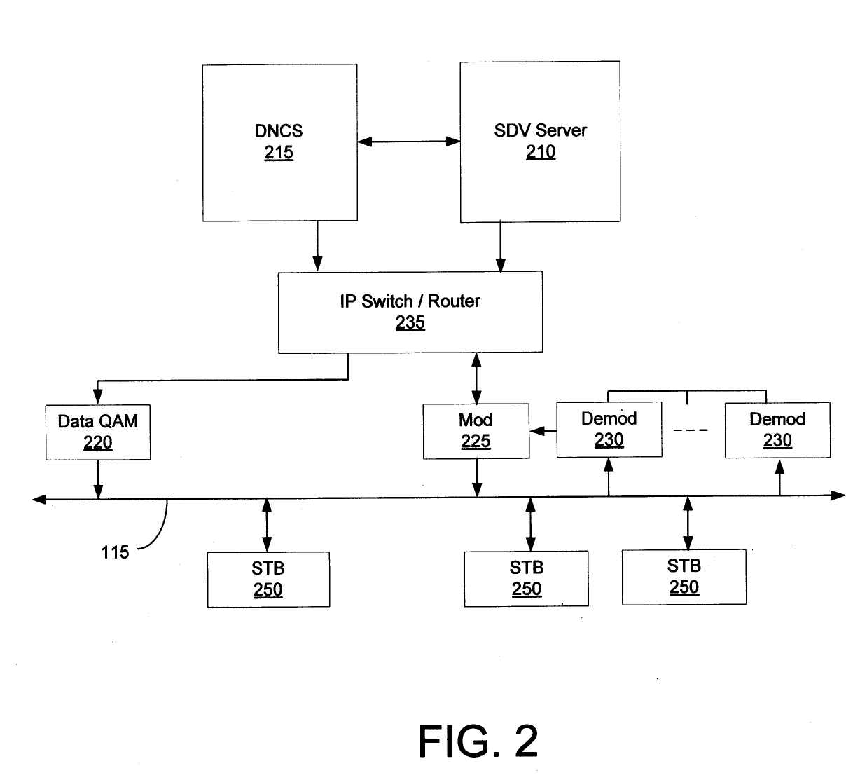

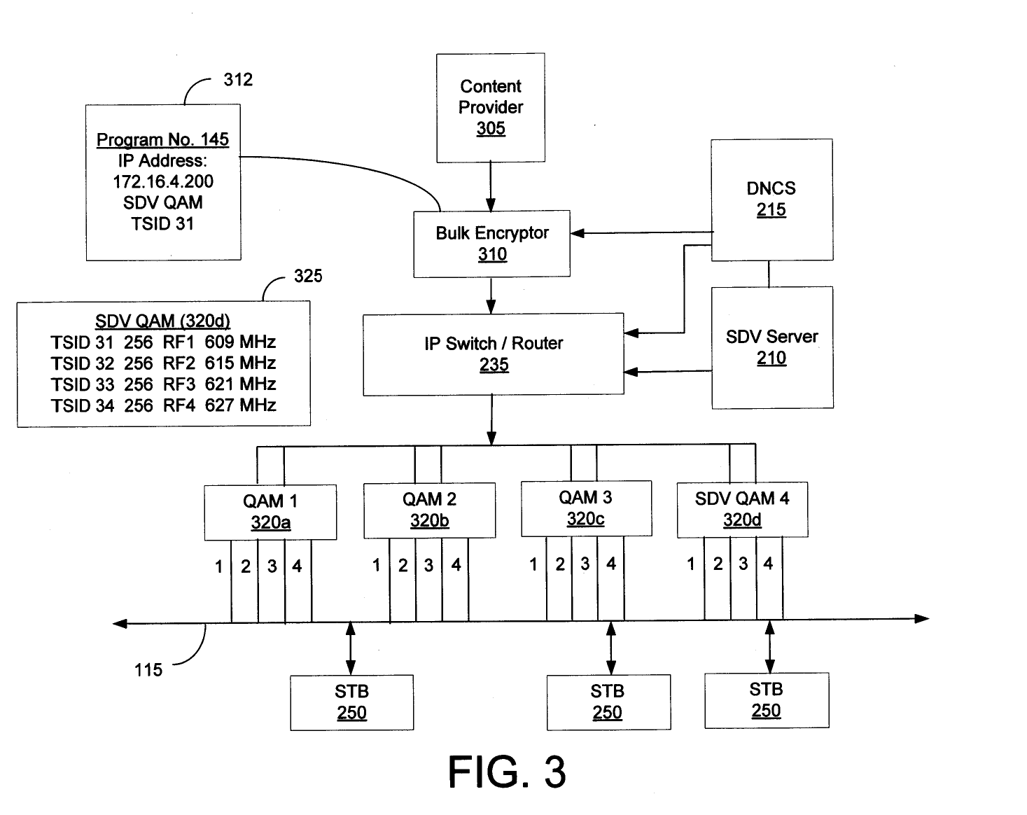

FIG. 2 is an abridged block diagram of data provider devices that are suitable for use in the communications system of FIG. 1 as well as implementing an SDV system. An SDV server 210, a digital network control system (DNCS) 215, and edge devices, such as a data quadrature amplitude modulation (QAM) 220, modulators 225, and demodulators 230, among others, cooperate in order to implement an SDV system. The DNCS 215 provisions, monitors, and controls the data and devices in the system 100. Also, the DNCS 215 reserves bandwidth on the edge devices (such as SDV QAM modulator 320d (FIG. 3)). Other servers, such as an application server and a VOD server exist, but are not shown for simplicity. An Internet protocol (IP) switch/router 235 routes received data packets, which may include broadcast file system (BFS) data; interactive program guide (IPG) data; set-top box (STB) software; channels (or services) and their associated frequencies, and SDV information contained in an SDV mini-carousel; according to their packet headers. Generally, in-band data packets are provided to the IP switch/router 235, which provides the multiplexed packets to a data QAM 220 for modulating. Alternatively, the IP switch/router 235 routes the data packets to an out-of-band data path. Out-of-band data packets are IP packets that require modulation by modulator 225. The modulated IP packets are then provided to the transport network 115 for routing to one or more particular STBs 250.

FIG. 3 is an abridged block diagram of program provider devices that are suitable for use in the communications system of FIG. 1 as well as implementing an SDV system. Content providers 305 generate and transmit programs where there are non-SDV and SDV programs. Under the direction of the DNCS 215, a bulk encryptor 310 processes the programs from the content provider 305. An SDV program set-up 312 is illustrated by way of example. IP address 172.16.4.200 at the content provider 305 is accessed to receive SDV program number 145. The bulk encryptor 310 adds an intended modulator, e.g., SDV QAM 320d, and assigns the program data a transport stream identification (TSID), e.g., TSID 31. For all programs (i.e., SDV programs and non-SDV programs), the intended QAM(s) 320a-d modulate the programs onto a radio frequency (RF) carrier for transport on the transport network 115. For example, TSID 31 is modulated with 256 QAM and is transmitted on output port RF 1 of SDV QAM 320d at 609 MHz. An SDV QAM set-up 325 is illustrated by way of example including other SDV TSIDs and their output ports and frequency. It will be appreciated that the present invention is not limited to QAM modulation, but rather envisions any type of modulation scheme; additionally, the modulators can also be multi-modulators and/or Gigabit Ethernet (GbE) QAM modulators.

In an SDV system, the SDV server 210 requests a group of shell sessions designated as a TSID from the DNCS 215. The DNCS 215 then creates the session group utilizing at least one QAM that is designated to be the SDV QAM (e.g., SDV QAM 320d). More specifically, the DNCS 215 transmits information regarding the created session group, which may include from one (1) to 32 shell sessions on the same RF carrier frequency, to the SDV QAM 320d based on the SDV QAM's overall bandwidth capacity. The shell group information contains the list of session identifiers in the group and the total group bandwidth. The DNCS 215 then returns the service group, which may include up to 32 session identifiers, and corresponding tuning parameters (e.g., RF carrier frequency, QAM modulation format, etc.) to the SDV server 210. Additionally, the DNCS 215 performs as a bandwidth proxy manager to ensure that the SDV QAM 320d shares bandwidth among all services, i.e., VOD sessions, SDV sessions, and broadcast services, as necessary. For example, the SDV QAM 320d may also transmit VOD sessions in addition to SDV sessions.

The SDV server 210 manages the shell group session names and associated identifiers and the group bandwidth. More specifically, the SDV server 210 can use any of the SDV session identifiers within the established shell group and assign any amount of bandwidth for SDV sessions so long as the assigned bandwidth does not exceed the shell group bandwidth. Once the shell group is established, the SDV server 210 can begin to bind SDV sessions programs according to a subscriber's request to a transport stream. The SDV QAM 320d binds a given SDV program to a transport stream by issuing a membership report using a multicast group destination address (GDA) associated with the program. The SDV session is deemed established when binding is successful. The SDV server 210 may also provide alternate content source IP addresses in the event that the connection with the first content provider is disconnected. The SDV server 210 also specifically specifies a program name (e.g., SDV1), a program, or session identifier (e.g., 000a73df0c9a00000000), the amount of bandwidth (e.g., 7 Mb/s) required for that program, and an MPEG program number, which specifies the actual program identifiers of the selected SDV program. Additionally, the SDV server 210 may request the SDV QAM 320d to unbind any SDV program by sending an unbind request and the program identifier. Furthermore, the SDV server 210 may also query the SDV QAM 320d for bindings, and accordingly the SDV QAM 320b responds back to the SDV server 210.

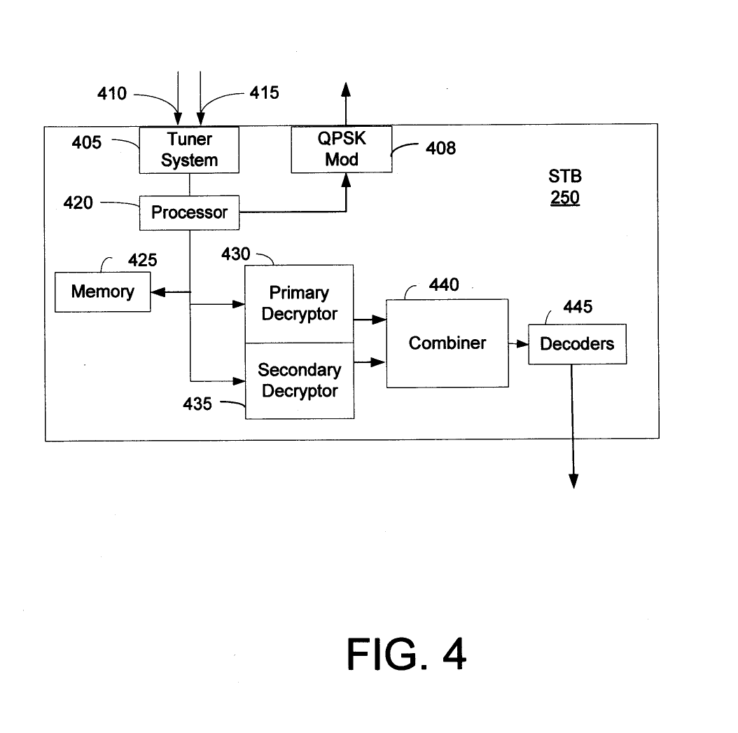

FIG. 4 is an abridged block diagram of a set-top box (STB) 250 that is suitable for use in implementing the present invention. The STB 250 may request an SDV program (e.g., SDV1) by selecting from a program guide or tuning to via a tuner system 405. A request is generated by the STB 250 and transmitted to the SDV server 210 via, for example, a quadrature phase shift key (QPSK) modulator 408. Another transmission device may be a modem. One of the demodulators 230 demodulates the request and forwards the request to the SDV server 210 via modulator 225. If the program is not already broadcasting and bandwidth is available, the SDV server 210 binds the requested SDV program to a particular RF carrier frequency. The tuner system 405, which may include a single tuner or more than one tuner, then begins to receive and filter the desired program that is broadcasted on the SDV service. The SDV program is typically received on an in-band port 410 (i.e., transmitted via the SDV QAM 320d), but in some cases may also be received on an out-of-band port 415 (i.e., transmitted via the modulator 225). A processor 420 processes the program in a known manner and routes the program to memory 425 for storing and/or to one of a primary decryptor 430 or a secondary decryptor 435 for decryption. The primary decryptor 430 typically decrypts the program when it is to be displayed on a television's main display screen. The secondary decryptor 435 is typically used when the program is to be displayed in a picture-in-picture (PIP) screen located within the main display screen or when a second program is being recorded. A combiner 440 combines the two programs from the decryptors 430, 435, if necessary, and one or more decoders 445 then decode the programs for display on the television.

It will be appreciated that if the SDV service has not previously been requested by any of the plurality of STBs 250 and, therefore, is not being broadcasted, a barker may be displayed on the television 500 until the SDV service is received. Barkers may also be used when an STB 250 is not authorized for the SDV service; when there is not enough bandwidth; and when the SDV service is no longer available, to name some examples.

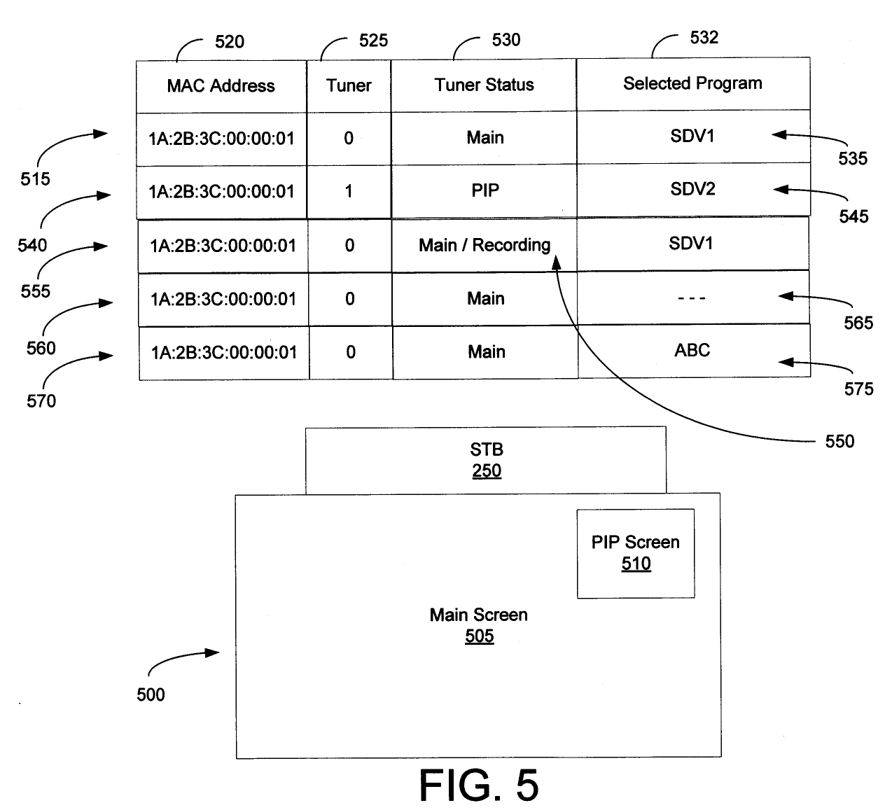

FIG. 5 is a block diagram of a television 500 displaying a first SDV program on a main screen 505 and a second SDV program on a PIP screen 510. More specifically, the STB 250 tunes to a desired channel, or RF carrier frequency, that is an SDV service. The STB 250 generates a program select request 515 for the SDV program 535 (e.g., SDV1), and, if bandwidth is available, the SDV server 210 broadcasts SDV1 535 in response. Subsequently, SDV1 535 is displayed on the main screen 505. Additionally, the STB 250 may generate a second program select request 540 for a second SDV program 545 (e.g., SDV2) for the PIP screen 510. Again, if bandwidth is available, the SDV server 210 broadcasts SDV2 545 in response. In both requests 515, 540, when each tuner tunes to a service, the STB 250 generates the reverse requests, or program select requests 515, 540, that include the STB media access control (MAC) address 520 (e.g., 1A:2B:3C:00:00:01), a tuner identity 525, if necessary, that identifies which tuner in a multiple tuner system 405 is filtering the requested SDV service, tuner status 530 (e.g., tuner 0 is providing SDV1 to the main screen and tuner 1 is providing SDV2 to the PIP screen), and the selected program 530 (e.g., SDV1 and SDV2) or some other session identifier.

Furthermore, since reverse requests are transmitted from the STB 250 to the SDV server 210 with every tuner or processor 420 change, when a tuner changes its use or discontinues showing a program for another program, a reverse request (e.g., a program select request or other event indication) is transmitted to the SDV server 210. By way of example, along with displaying SDV1 535 on the main screen, it may also be recorded in memory. In this case, a reverse request 550, or event indication, is transmitted indicating the tuner status change from main to main/recording 555. Also, when the channel is tuned away from SDV1, a reverse request 560, or event indication, is transmitted indicating tuner 0 is filtering no program 565, for example. In this manner, SDV server 210 receives notification that SDV1 is no longer desired at this STB. Additionally, when the STB is tuned to another program, program select request is transmitted stating the latest tuner status. For example, tuner 0 has tuned to broadcasted channel ABC 575. Accordingly, program select request 570 is transmitted. It will be appreciated that non-SDV program select requests are provided to the SDV server 210, but no action is required of the SDV server 210 since the non-SDV programs (e.g., ABC 575) are broadcasted and available to every STB.

In accordance with the present invention, since the main screen 505 and the PIP screen 510 are both displaying an SDV program, SDV1 535 may take a higher priority than SDV2 540. In the event of low bandwidth, the SDV server 210 can unbind SDV2 540 freeing bandwidth for higher priority SDV services that may have been requested from this subscriber's premise or elsewhere off the coupled edge device.

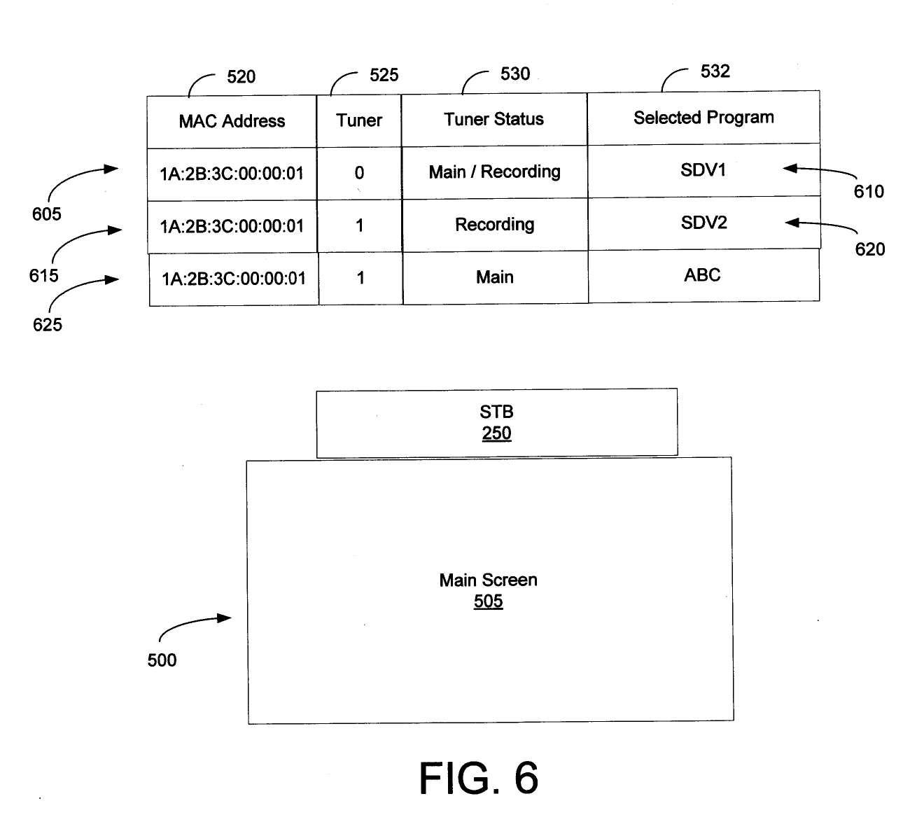

FIG. 6 is a block diagram of the television 500 displaying a first SDV program 610 on the main screen 505 and the STB 250 recording a second SDV program 620 to memory 425. More specifically, the STB 250 tunes to a desired channel that is designated as an SDV program (e.g., SDV1). The STB 250 generates a program select request 605 for SDV1 610, which indicates that SDV1 will be watched on the main screen as well as recorded, and, depending upon the available bandwidth, the SDV server 210 broadcasts SDV1 610 in response. Furthermore, the STB 250 may generate a second program select request 615 for a second SDV program 620 that will also be recorded in memory 425. Again, if bandwidth is available, the SDV server 210 broadcasts SDV2 620 in response. As mentioned, a program select request 625 is transmitted from the STB 250 to the SDV server 210 when the recording time has ended and/or tuner 1 tunes to another channel.

In accordance with the present invention, since the main screen 505 is displaying and recording SDV1 610 as well as the recording SDV2 620, the recorded SDV programs 610, 620 may take a higher priority than other broadcasted SDV programs being requested or transmitted in the system. In the event of low bandwidth, the SDV server 210 can deny requested SDV programs and/or unbind lower priority SDV programs, such as an SDV program that is being displayed in a PIP, thereby freeing bandwidth for requested higher priority SDV programs.

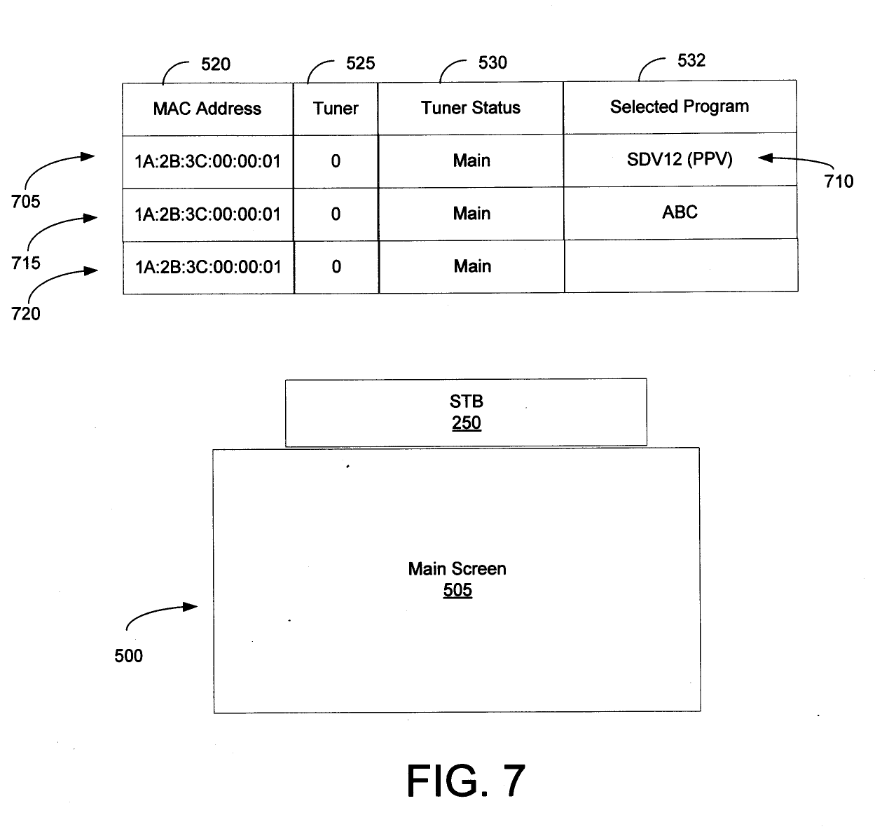

FIG. 7 is a block diagram of the television 500 displaying a pay-per-view (PPV) SDV program on the main screen 505. More specifically, the STB 250 tunes to a desired channel, that is designated as a PPV SDV program 710 (e.g., SDV12 (PPV)). As mentioned, the STB 250 generates a program select request 705 for SDV12 (PPV) 710, and, based on available bandwidth, the SDV server 210 transmits SDV12 (PPV) 710 in response. Subsequently, SDV12 (PPV) 710 is displayed on the main screen 505. A program select request 715, 720 is again transmitted from the STB 250 to the SDV server 210 indicating when the STB 250 has tuned away from SDV12 (PPV) 710 and is no longer required or when the STB 250 is turned off, for example.

In accordance with the present invention, since the main screen 505 is displaying a PPV SDV program, SDV12 (PPV) 710 may take a higher priority than other SDV programs being requested and/or broadcasted in that RF carrier frequency. In the event of low bandwidth, the SDV server 210 can deny access to requested programs and/or unbind other lower priority SDV programs within the PPV SDV program's shell group, thereby freeing bandwidth for higher priority SDV programs.

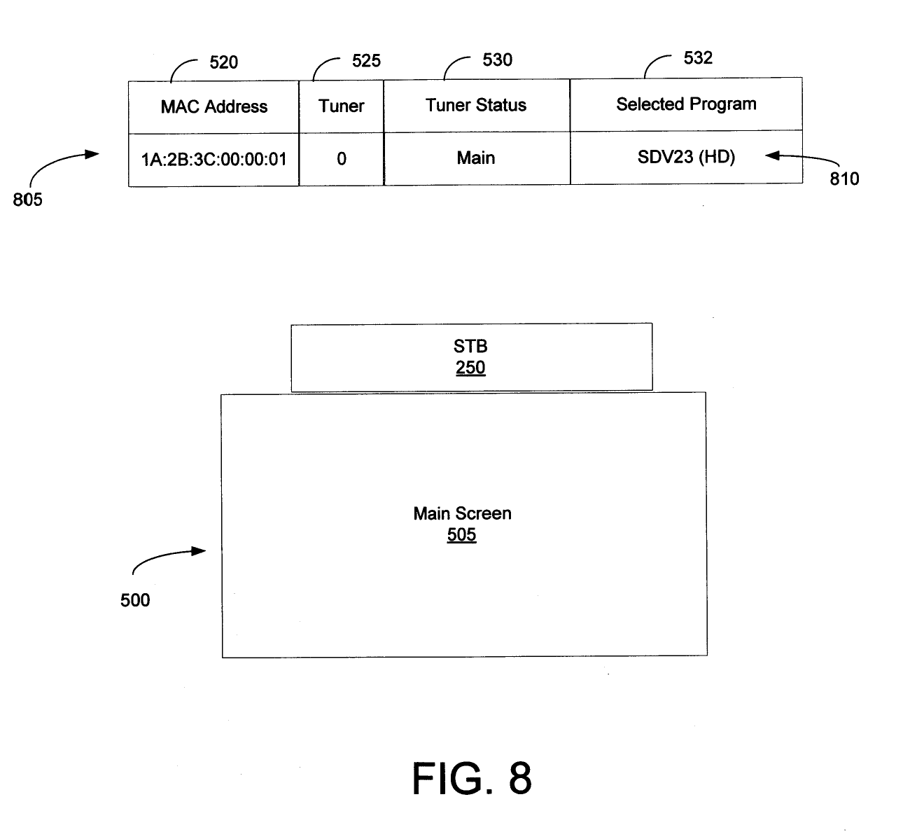

FIG. 8 is a block diagram of the STB 250 requesting a high definition (HD) SDV program that will be displayed on the main screen 505. More specifically, the STB 250 tunes to a desired channel that is an HD SDV program 810. The STB 250 generates a program select request 805 for the HD SDV service 810 (e.g., SDV23 (HD)), and, depending upon available bandwidth, the SDV server 210 broadcasts SDV23 (HD) 810 in response. Subsequently, SDV23 (HD) 810 is displayed on the main screen 505. In the event, however, there is not enough bandwidth for the HD program 810, the SDV server 210 looks at prioritization options. One example is to consider the current amount of available bandwidth. If there is not enough bandwidth to transmit the HD program 810, but there is enough bandwidth to transmit a standard definition (SD) of the program, the SDV server 210 may elect to transmit the SD version of the requested program 810. Subsequently, the SDV server 210 responds to the STB's program select request with tuning parameters for the SD version.

As another example of prioritization, the SDV server 210 may elect to downgrade a broadcasting HD program to an SD version when bandwidth becomes limited. The SDV server 210 sends a message to the STB when the transition from HD to SD occurs indicating the new tuning parameters for the SD version of the SDV program. The STB may also be notified of the tuning parameter change from information received from a carousel that is continually broadcasted. In this manner, the STB tunes to the new tuning parameters and continues receiving the program in the SD version.

In accordance with the present invention, the numerous requested SDV programs such as illustrated above can be prioritized by the SDV server 210. In this manner, selected SDV programs can take priority over other SDV programs, either with the same requesting STB or other STBs in the system. When a STB 250 requests a lower priority SDV program, the SDV server 210 binds the requested SDV program to the shell session group so long as there is sufficient bandwidth available. In the event that bandwidth is tight or not available, a lower priority SDV program may not be transmitted. Additionally, if a STB 250 requests a high priority SDV program and bandwidth is not available, the SDV server 210 may unbind lower priority SDV programs that are carried on the same RF carrier frequency as the higher priority SDV program in order to transmit the higher priority SDV program. Furthermore, the SDV server 210 may choose to broadcast an SDV program in a degraded manner, for example, instead of broadcasting an HD SDV program, the SDV server 210 may broadcast the SD version.

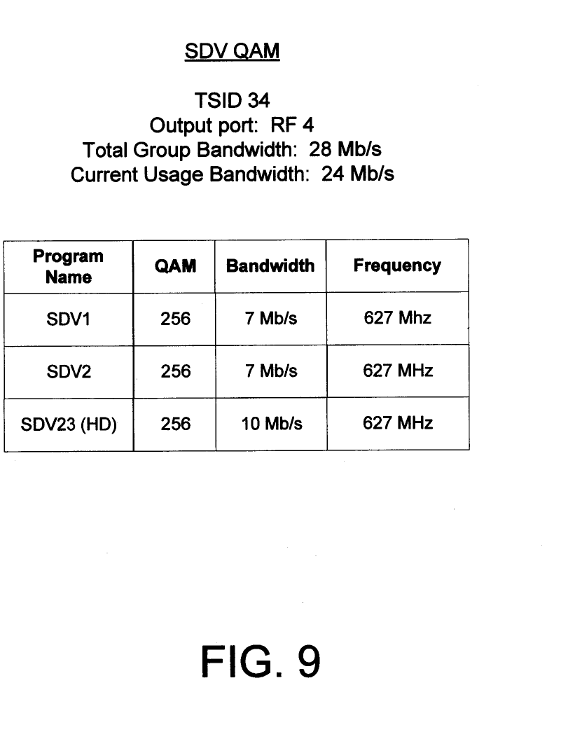

FIG. 9 is an illustration of the current programs that are grouped in TSID 34 and are broadcasted from SDV QAM 320d out of output port RF4. By way of example, the total group bandwidth for output port RF4 is 28 Mb/s. Using example SDV program select requests, three SDV programs are currently broadcasted in TSID 34. As noted in the table, SDV1, SDV2, and SDV23 (HD) are modulated with 256 QAM at an RF carrier frequency of 627 MHz. SDV1 and SDV2 require a bandwidth of 7 Mb/s each. SDV23 (HD) requires more bandwidth due to more data transmitted in an HD format. Therefore, the current usage bandwidth for output port RF4 is 24 Mb/s, which is within the total group bandwidth.

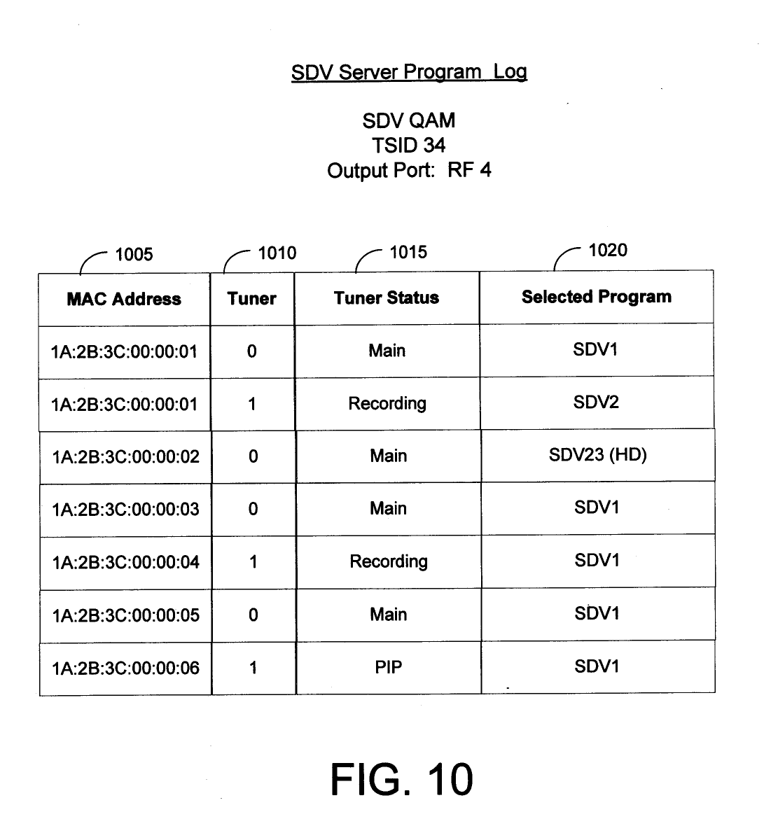

FIG. 10 illustrates an SDV server program log, which tracks current SDV programs. Specifically for SDV QAM TSID 34 having output port RF 4, the program log tracks the current MAC addresses, tuners, tuner status, and selected programs. A program log exists for each shell group broadcasted in the SDV system. Referring also to FIG. 9, this example tracks which programs are actively being watched and/or recorded. When the SDV server 210 receives a program select response from a STB 250, the program log is updated accordingly. For example, SDV1 is being displayed by five STBs; SDV2 is being recorded by one STB; and SDV23 (HD) is being displayed by one STB.

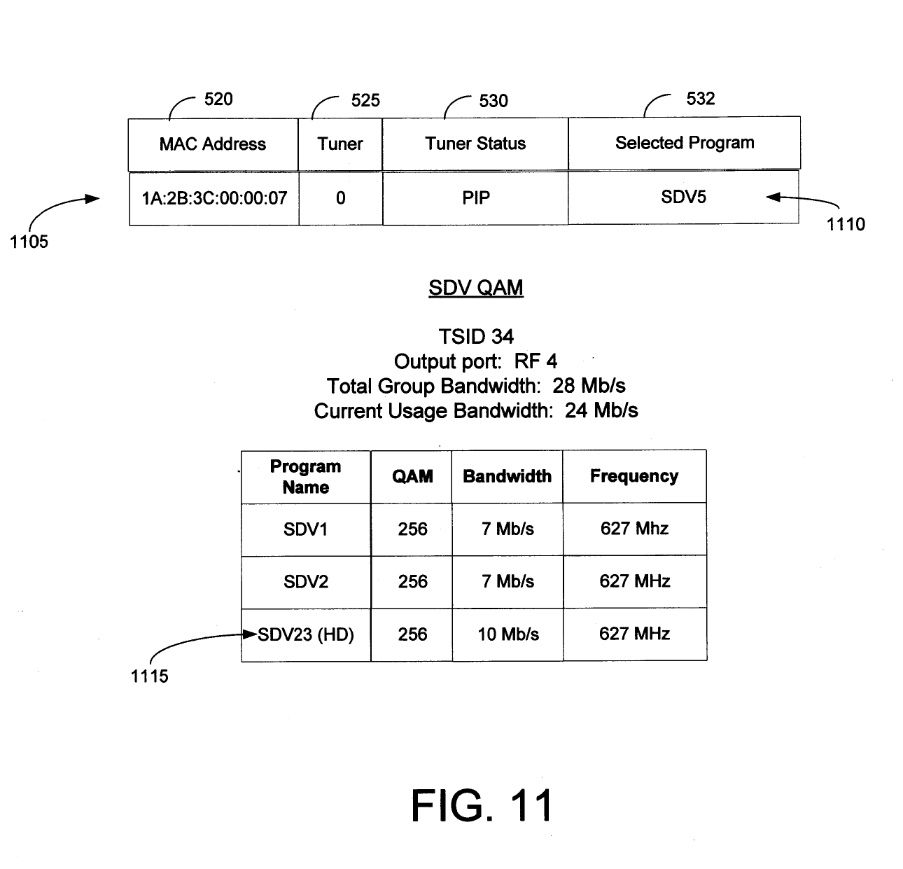

FIG. 11 illustrates a new program select request 1105 from a STB requesting an SDV program. The program select request 1105 is requesting SDV5 1110, which requires 7 Mb/s of available bandwidth, to be viewed on the PIP screen. Since the current output on port RF 4 is almost at the bandwidth group limit of 28 Mb/s, the SDV server 210 may in accordance with the present invention prioritize the current SDV programs on that output frequency. SDV23 (HD) requires 10 Mb/s, and, referring to FIG. 10, many STBs are currently viewing SDV1 and one STB is currently recording SDV2. In this case, the SDV server 210 may elect to unbind SDV23 (HD) and, in its place, bind the SD format of this program, which requires less than 10 Mb/s, for example, 7 Mb/s, as well as meet the request for the new SDV5 program 1110.

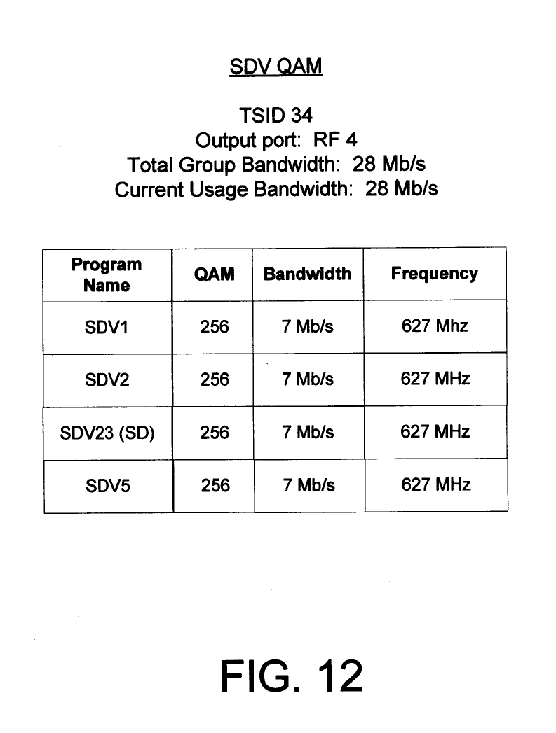

FIG. 12 illustrates the updated programs that are grouped in TSID 34 and are broadcasted from SDV QAM 320d out of output port RF4. The SDV QAM is now broadcasting SDV23 (SD) and SDV5 in addition to SDV1 and SDV2. The total usage bandwidth is now 28 Mb/s, which is within the total group bandwidth.

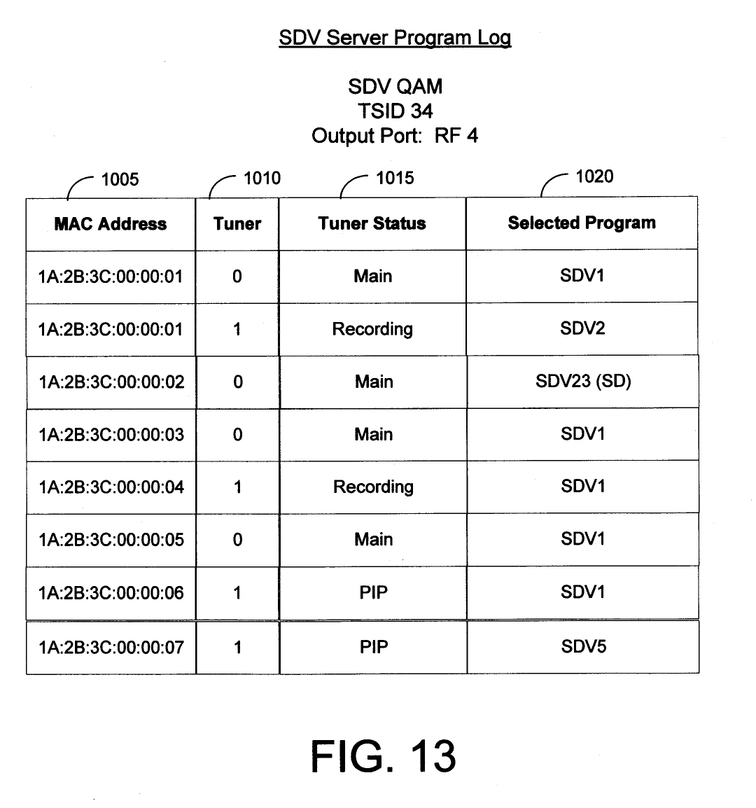

FIG. 13 illustrates an updated SDV server program log. With the changes in the SDV program group, the SDV server program log is updated to reflect that STB having a MAC address of 1A:2B:3C:00:00:02 is currently viewing SDV23 (SD). Additionally, the STB having a MAC address of 1A:2B:3C:00:00:07 is currently viewing SDV5 in the PIP screen.

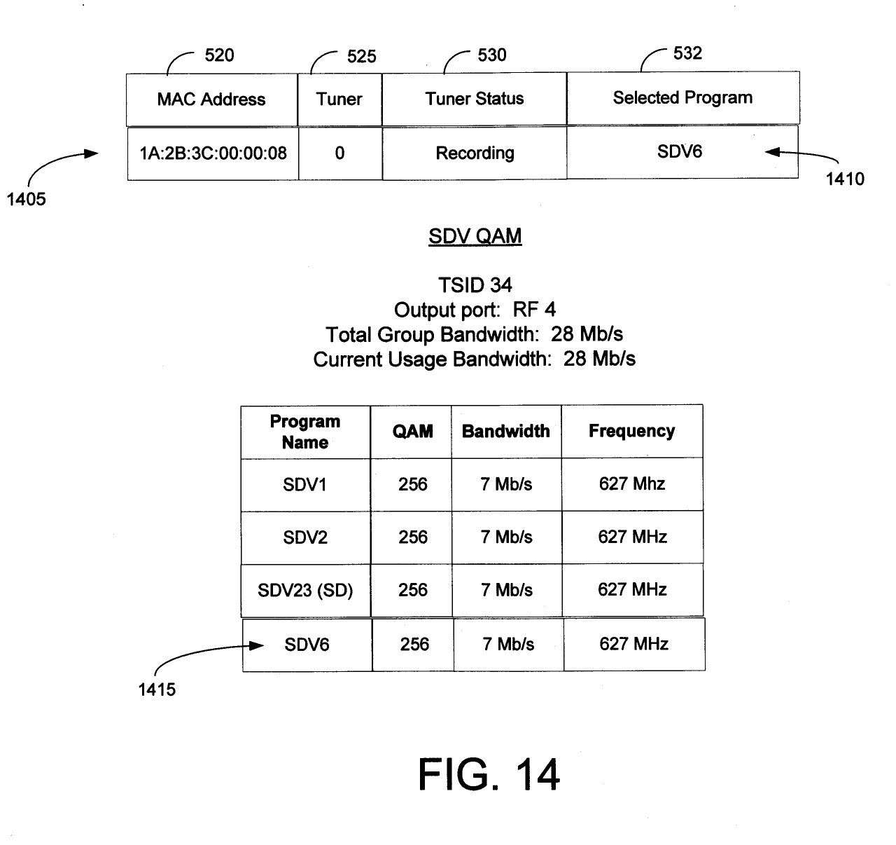

FIG. 14 illustrates a new program select request from a STB requesting a new SDV program. The new program select request 1405 is requesting SDV6 1410 that will be recorded. As the requesting STB waits for the SDV server 210 to broadcast SDV6, the SDV server 210 evaluates the available bandwidth. In this example, there is no available bandwidth to broadcast SDV6. The SDV server 210 can then prioritize the SDV programs to determine the best possible programs that can be broadcasted. The SDV server 210 can either alert the requesting STB that bandwidth is not available at this time or the SDV server 210 can unbind another SDV program in TSID 34 that is lower priority, in this case SDV5 that is being watched in PIP, for example.

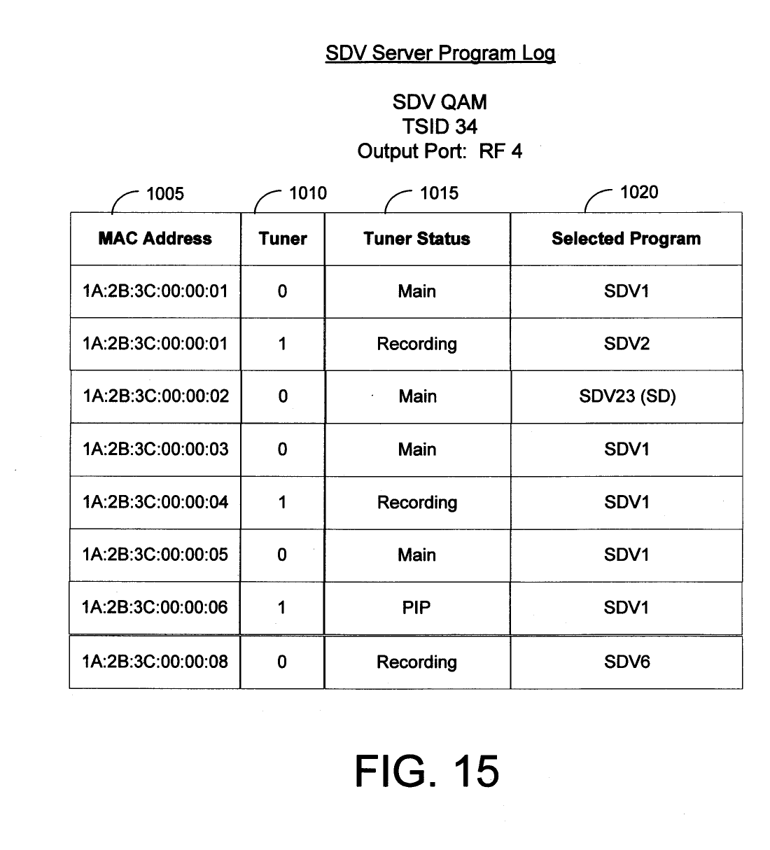

FIG. 15 illustrates an updated SDV server program log indicating the current STBs and their activity. According to best practices, the SDV server 210 either waited until SDV5 was no longer actively being watched and/or recorded or SDV5 was considered lower priority since it was being viewed on a PIP screen rather than on a main screen. Either way, FIG. 15 illustrates that SDV5 is no longer active and SDV6 is now being broadcasted.

Accordingly, systems and methods have been provided that enables an SDV server to prioritize SDV programs. It is understood that the description and drawings are just examples and can be customized by a system operator depending upon current business practices. For example, prioritization of the SDV sessions can be selected and changed according to the system operator's marketing objectives. Additionally, other devices can be used in the SDV system rather than the devices used and described in the description, such as, for example, a cable modem or a computer can be used to replace the STB. It will be appreciated that further embodiments are envisioned that implement the invention, for example, using all software or adding modes for additional features and services.

What is claimed is:

1. A method for broadcasting programs in a switched digital video (SDV) system, the method comprising the steps of:
receiving a request for an SDV program;
determining available bandwidth of an RF carrier frequency;
if bandwidth is available, broadcasting the requested SDV program on the RF carrier frequency along with other broadcasting SDV programs;
if bandwidth is unavailable, determining a priority of the requested SDV program compared to priorities of the other SDV programs; and
broadcasting the SDV programs that are within the available bandwidth of the RF carrier frequency having a highest priority.

2. The method of claim 1, wherein determining the priorities of the requested SDV program and the other SDV programs comprises the steps of:
retrieving an SDV program log, the SDV program log comprising tuner status and a corresponding SDV program for an active set-top box (STB); and
determining the priority based on the tuner status.

3. The method of claim 2, wherein the tuner status may be one or more of providing a corresponding SDV program to a main screen, a picture-in-picture (PIP) screen, a pay-per-view (PPV) event, or a recording function.

4. The method of claim 1, wherein determining the priorities of the requested SDV program and the other SDV programs comprises the steps of:
retrieving an SDV program log, the SDV program log comprising tuner status and a corresponding SDV program for an active STB; and
determining the priority based on how many active STBs are tuning a same SDV program.

5. The method of claim 1, wherein determining the priorities of the requested SDV program and the other SDV programs comprises the steps of:
retrieving an SDV program log, the SDV program log comprising tuner status and a corresponding SDV program for an active STB, wherein one or more of the corresponding SDV programs is a high definition (HD) SDV program; and
determining the priority based on the presence of the one or more HD SDV programs.

6. The method of claim 5, wherein, when bandwidth is limited, assigning the HD SDV program a lower priority when a standard definition (SD) format of the HD SDV program is available for broadcasting.

7. The method of claim 6, wherein, when bandwidth is available, assigning the HD SDV program a higher priority than the SD format, wherein the SD format of the HD SDV program is no longer transmitted and the HD SDV program is transmitted.

8. The method of claim 1, wherein determining the priorities of the requested SDV program and the other SDV programs comprises the steps of:
retrieving an SDV program log, the SDV program log comprising tuner status and a corresponding SDV program for an active STB, wherein one or more of the corresponding SDV programs may be a pay-per-view (PPV) SDV program; and
determining the priority based on the presence of a PPV SDV program.

9. The method of claim 1, further comprising the step of terminating at least one of the broadcasting SDV programs having a lower priority in order to begin broadcasting the request for the SDV program, wherein the requested SDV program has a higher priority.

10. The method of claim 9, further comprising the step of updating an SDV program log with the broadcasting SDV programs, the program log comprising tuner status of an STB and a corresponding SDV program.

11. A switched digital video (SDV) system comprising an SDV server for broadcasting SDV programs on demand when bandwidth is available, the SDV server comprising:
a processor for receiving a request for an SDV program, and for determining available bandwidth of an RF carrier frequency,
wherein, when bandwidth is available, broadcasting the requested SDV program on the RF carrier frequency along with other broadcasting SDV programs, and
wherein, when bandwidth is unavailable, determining a priority of the requested SDV program compared to priorities of the other broadcasting SDV programs,
wherein the SDV programs are broadcasted on the RF carrier frequency having highest priorities that are within the available bandwidth.

12. The SDV server of claim 11, further comprising memory for storing an SDV program log, the SDV program log comprises tuner status and a corresponding SDV program for an active set-top box (STB), wherein the priority of SDV programs is based on the tuner status of each STB.

13. The SDV server of claim 12, wherein the tuner status may be one or more of a main screen function, a PIP screen function, a PPV event, or a recording function.

14. The SDV server of claim 11, further comprising memory for storing an SDV program log, the SDV program log comprises tuner status and a corresponding SDV program for an active set-top box (STB), wherein the priority of SDV programs is based on how many active STBs are tuning a same SDV program.

15. The SDV server of claim 11, further comprising memory for storing an SDV program log, the SDV program log comprises tuner status and a corresponding SDV program for an active set-top box (STB), wherein one or more of the corresponding SDV programs is a high definition (HD) SDV program, wherein the priority of SDV programs is based on the presence of the one or more HD SDV programs.

16. The SDV server of claim 15, wherein, when bandwidth is limited, the one or more HD SDV programs is determined to be a lower priority when a standard definition (SD) format of the HD SDV program is available for broadcasting.

17. The SDV server of claim 16, wherein, when bandwidth is available, the one or more HD SDV programs are higher priority than the SD format, wherein the SD format of the HD SDV program is no longer transmitted and the HD SDV program is transmitted.

18. The SDV server of claim 11, further comprising memory for storing an SDV program log, the SDV program log comprises tuner status and a corresponding SDV program for an active set-top box (STB), wherein one or more of the corresponding SDV programs is a pay-per-view (PPV) SDV program, wherein the priority of SDV programs is based on the presence of the one or more PPV SDV programs.

19. The SDV server of claim 11, wherein the processor terminates at least one of the broadcasting SDV programs having a lower priority in order to begin broadcasting the requested SDV program, wherein the requested SDV program has a higher priority.

20. The method of claim 18, wherein the processor updates an SDV program log with the broadcasting SDV programs, the program log comprising tuner status of an STB and a corresponding SDV program.

21. A switched digital video (SDV) system comprising an SDV server for broadcasting SDV programs on demand when bandwidth is available, the SDV system comprising:
a plurality of STBs each for transmitting a request for an SDV program; and
an SDV server for managing the broadcasting SDV programs, the SDV server comprising:
a processor for receiving the request, and for determining available bandwidth of an RF carrier frequency,
wherein, when bandwidth is available, broadcasting the requested SDV program on the RF carrier frequency along with other broadcasting SDV programs, and
wherein, when bandwidth is unavailable, determining a priority of the requested SDV program compared to priorities of the other broadcasting SDV programs,
wherein the SDV programs are broadcasted on the RF carrier frequency having highest priorities that are within the available bandwidth, and wherein a message is transmitted to a STB that requested a lowest priority SDV program.

22. The SDV system of claim 21, wherein the SDV server updates an SDV program log with the broadcasting SDV programs, the program log comprising tuner status of an STB and a corresponding SDV program.
